(19) United States
(12) Patent Application Publication
(10) Pub. No.: US 2007/0102579 A1
(43) Pub. Date: May 10, 2007

(54) Modular structure

(75) Inventors: Leif Krieglsteiner, Munchen (DE); Florian Schmidt, Ahrensburg (DE); Oliver Doebertin, Hamburg (DE); Hermann Schotte, Buxtehude (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/531,600

(22) Filed: Sep. 13, 2006

Related U.S. Application Data
(60) Provisional application No. 60/716,798, filed on Sep. 13, 2005.

(30) Foreign Application Priority Data
Sep. 13, 2005 (DE) 10 2005 043 610.2

(51) Int. Cl. B64C 1/00

(52) U.S. Cl. 244/129.1

(57) ABSTRACT

A structure for use in an aircraft includes a housing for the modular mounting of the structure to an aircraft structure. The structure includes at least one removable module to which advertising media may be fixed. Furthermore, the structure includes fixing elements by which the housing is fixable to fixing elements of an aircraft structure. In one example, the housing is fixed to a predetermined position of an aircraft structure.

### REFERENCE TO RELATED APPLICATIONS

This application claims the benefit of the filing date of U.S. Provisional Patent Application No. 60/716,798 filed Sep. 13, 2005, and of German Patent application DE 10 2005 043 610.2 filed Sep. 13, 2005, the disclosures of which are hereby incorporated herein by reference.

### FIELD OF THE INVENTION

The field relates to aircraft interior structures. In particular, the field relates to cabinets for use in aircraft.

### BACKGROUND

The catering to passengers and the sale of merchandise items in an aircraft is so far limited to trolleys or the on-board shop. This on-board service for the sale of merchandise items and for the catering to passengers is run exclusively by the airline itself. Thereby, mobile means of transport, so-called trolleys, which are moved between the seat rows by a flight attendant in direction of the longitudinal axis of the aircraft body, are used. Currently, catering to passengers and the sale of merchandise items are undertaken exclusively by the flight attendant.

### SUMMARY OF THE INVENTION

One object is to provide a device for increasing service offerings for the passengers.

According to one embodiment, a structure for an aircraft having a housing on which a modular construction is capable of being mounted. The structure comprises at least one removable module on which advertising media may be fixed. Furthermore, the structure comprises fixing elements capable of being fixed to the housing. The fixing elements on the housing of the structure are fixed to fixing elements of an aircraft area, wherein the housing may thus be fixed at a predetermined position of an aircraft structure.

According to another embodiment, a method for operating a structure for an aircraft, whereby in a first step, at least one removable module is mounted to a housing of a structure and, in another step, advertising media are fixed on the removable module. In another step, the housing is fixed by means of fixing elements, whereby the fixing elements are fixed to fixing elements of an aircraft structure. The housing is thus fixable at a predetermined position of an aircraft structure.

According to yet another embodiment, an aircraft with a structure with the features described above is created. According to another embodiment, a structure with the features described above is used in an aircraft.

In an embodiment, a flexible and modularly constructed structure is created by which service offerings for passengers may be significantly increased and new revenue streams may be generated for the airline. The service offerings for the passengers is increased. For example, a structure firmly connected to the aircraft floor, provides an additional entertainment program or a service program for the airline passengers. The inventive structure may be mounted and save space and flexibly at certain fixing positions in an aircraft, thus adjusting to different cabin layouts. In an embodiment, the structure may offer passenger new entertainment such as additional televisions or Internet access, as well as service offerings of possible external companies, such as drinks and snack dispensers. For this purpose, in an embodiment, the structure may be designed for franchise usage. The structure is modularly designed and may thus be quickly installed and disassembled. With regard to changing franchise partners, in an embodiment, the structure may be adjusted in its design, its color, its form and its intended use.

According to another embodiment, the fixing elements of the structure are provided according to aircraft-specific standards. According to another embodiment, the inventive fixing elements are dimensioned in such a way to couple with a seat slide of an aircraft. The connection with the fixing elements is thereby flexibly and removably provided in order to quickly adjust and, if necessary, quickly disassemble and dismount the structure. According to requirements, the replacing or the adjusting and adapting of the structure may thus be made possible during turn-around times between two flight routes.

According to another embodiment, the structure has advertising media of different shapes that may be fixed to the removable module.

According to another embodiment, the structure has an opening and an interior with built-in areas. The built-in areas may be designed in such a way that diverse service devices may be installed in the structure and may be reachable through the opening.

According to another embodiment, the opening has a window and a counter. The window offers protection for the service devices within the structure. At the same time, additional depositing structures may be provided.

According to another embodiment, the structure has a first door element and a second door element. By opening and closing the door elements, the space may be variably adjusted. For example, the structure with closed doors may allow for conservation of space and in use, may be safer during the takeoff and landing of the aircraft. In this example, use of a service device opens the doors. Security during critical takeoffs and landings is enhanced, since the space-saving structure avoids the narrowing of the escape routes.

According to another embodiment, the first door element, the second door element, the advertising medium or the built-in area may respectively have different geometric forms, yet they may be replaceably connected to the structure. Thus, it may be reacted flexibly to the respective requirements of the structure. If, on the one hand, the structure includes a drinks dispenser, the service unit, on the other hand, may be quickly equipped with entertainment devices, as, for example, a radio or a television. Thus, there is the possibility for the airline between the individual flight routes to quickly react to the respective needs. If, for example, a flight is fully booked, the structure may present drinks or snack dispensers to relieve the service staff. On a flight not fully booked, entertainment devices serve for the entertainment of the passengers. Thus, the quality and service performance of an airline is vastly increased.

According to another embodiment, at least the first door element, the second door element, the advertising medium, and the mounting area may be mounted modularly replaceably to the housing. This increases the variability of the field of application of the structure, so that it may be reacted quickly and flexibly to the different needs and requirements.

According to another embodiment, the first door element, the second door element, at least one removable module, the built-in area, and the advertising medium have fasteners. According to another embodiment, the fasteners are selected from the group consisting of hook and loop connections, plug connections, magnetic connections, staple connections, glue connections, put-over connections (Stülpverbindungen), screw connections, and welded connections. Depending on the field of application, very flexible fasteners may be selected in order to very quickly and flexibly adjust the structure to the respective application condition. In critical areas in which high vibrations are predominant or security aspects are very relevant, an inflexible, non-removable fastener, for example a welded connection, may be used.

According to another embodiment, the first door element and the second door element have removable modules for the connecting of advertising media. In one example, information notes, for example, information regarding safety precautions, the emergency exit distribution, menus, or advertising elements, may be connected. Thus, the respective airline may use the structure very flexibly in order to systematically provide the passenger with information. In one example, the modules may display information on a screen or display. The display may be updated remotely or may be pre-programmed.

According to another embodiment, at least one of the first door elements and the second door elements has built-in areas. In addition to the structure, the first or the second door element or both may be provided with service units. For example, a variety of products in the structure may be selected and inserted in one of the door elements of the payment device. Thus, by the use of functional door elements, a complete self-service process is provided.

According to another embodiment, at least one service unit may be fixed to at least one of the built-in areas. In another example, the service unit may be selected from the group consisting of a magazine and newspaper dispenser, a drinks dispenser, a headset dispenser, an information automat, an Internet kiosk or desk, a ticket machine, a fast food dispenser, and a snack dispenser. By using these service units, an airline may react very flexibly to the respective requirements of the passengers and the flight routes. For example, in long-range flights, passengers may thus serve themselves with various foods, for example, from a fast food dispenser, without causing strain on aircraft staff resources. Every airline may thus considerably improve its service.

According to another embodiment, a screen device may be mounted to at least one of the built-in areas. By means of this embodiment, the entertainment program in an aircraft may be improved and the customer satisfaction may be increased.

According to another embodiment, at least one from the group consisting of the structure, the first door element, the second element, the removable module and the advertising medium includes lighting elements for producing light effects and light reflections. By this embodiment, passengers' attention may be directed to the structure and, at the same time, advantageously adapt the structure in its design to the ambience of the cabin. Furthermore, the advertising media of the different franchisees may be emphasized.

According to another embodiment of the structure, the advertising media are selected from the group consisting of posters, foils, company-specific geometric forms, and characters. According to requirements, the airline may call attention to certain products and flexibly and quickly exchange the advertising media.

According to another embodiment of the method, at least one from the group consisting of the first door element, the second door element, the removable module, and the advertising medium is mounted to the structure by means of fasteners in an additional step.

According to another embodiment of the method, at least one built-in area is modularly, flexibly and removably mounted to at least one from the group consisting of the first door element, the second element, and the structure in an additional step.

According to another embodiment of the method, the first and the second door elements mounted to the structure are disassembled, in an additional step and subsequently, in a further step, third and fourth door elements are mounted to the same construction, whereby the third and fourth door elements have geometric forms which differ from those of the disassembled first and second door elements. These process steps may be allowed by the flexible fasteners. Thus, a structure may be flexibly and variably reconstructed. The third and fourth door elements may hereby have characteristics which may be the same, similar, or are different from the first and second door elements. Therefore, for example the franchisee of the structure may exchanged extremely quickly, resulting in the possibility for the airline to lease the structure to franchisees for specific flight routes.

According to another embodiment of the method, in a further step, an advertising medium is fixed to the at least one removable module of the first door element and the second door element. According to another embodiment of the method, a step of mounting a service unit to at least one built-in area is provided.

According to another embodiment of the method, a screen device is mounted to at least one mounting area in an additional step.

According to another embodiment of the method, an additional step of producing light effects or light reflections from at least one from the group consisting of the structure, the first door element, the second door element, the removable module, and the advertising medium is presented.

The structure thus offers an extremely space-saving and flexible device, that may considerably improve the service and information facilities. The structure may be installed and disassembled extremely quickly in order to react to the respective space requirements between the flight routes. Furthermore, service offerings are hence expanded and offer a higher customer satisfaction. For example, this is achieved on the one hand by being able to flexibly mount additional entertainment devices, and on the other hand, by relieving the on-board staff by adding additional service devices, such as drink dispensers. The use of a further embodiment of the structure offers the possibility to passengers to move towards the structures, so that by moving towards the structure, health risks such as the danger of thrombosis, may be minimized. The service devices mounted to the structure may further increase passengers service choices by the ability to choose service products at his or her free choice. Furthermore, by the mounting of entertainment units, for example, televisions, passengers may enjoy better entertainment. In the example of an Internet portal, the passengers may be provided with more information. Additionally, this structure achieves for the respective airline a considerably higher customer satisfaction and the possibility of additional revenue streams. In particular, the modularity of the structure and the variety of possible combinations may appeal to different franchisees that may rent the structure. By the flexible and quick reconstruction of the modular structure, it may be adjusted to different franchisees quickly and without difficult modifications in the cabin layout during the turn-around times, so that the structure may be leased to different franchisees in individual flight routes.

The embodiments also relate to the method and to the aircraft, as well as to the use and vice versa.

### BRIEF DESCRIPTION OF FIGURES

In the following, embodiments are described in greater details with reference to the accompanying drawings in order to provide a further illustration and understanding of the present invention. In the drawings:

FIG. 1 shows one example of a structure.

FIG. 2 shows a schematic representation of one example of the structure.

FIG. 3 shows a schematic three-dimensional representation of one example of the structure.

FIG. 4 shows another example of the structure.

FIG. 5 shows another examples of the structure.

FIG. 6 to 8 show other schematic examples of the structure.

FIG. 9 shows an example of the structure during the flight.

FIG. 10 shows an example of the structure during the takeoff and landing of an aircraft.

FIGS. 11 and 12 show a three-dimensional representation of possible mounting possibilities of the structure in a cabin layout.

### DETAILED DESCRIPTION OF EMBODIMENTS

The examples described and the drawings rendered are illustrative and are not to be read as limiting the scope of the invention as it is defined by the appended claims.

Same or like elements in the different figures are provided with the same reference numerals.

The representation in the figures is schematic and not full scale.

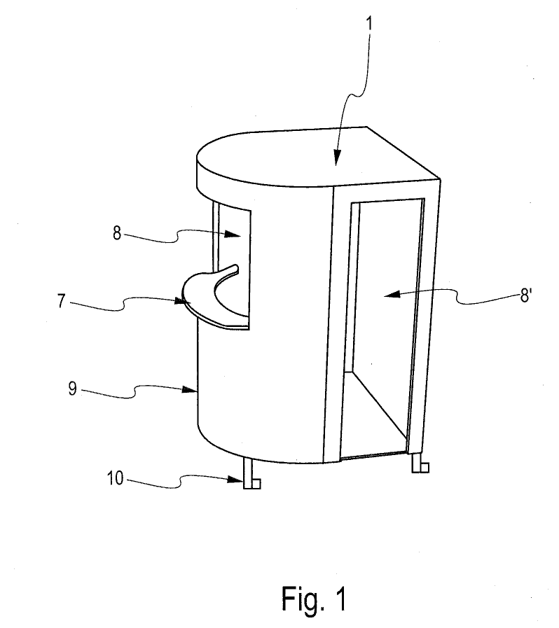

FIG. 1 shows a structure for an aircraft. A removable module 9 is mounted to the structure 1 to which advertising media 12 may be fixed. Furthermore, housing of the structure 1 may be fixed to corresponding fixing elements of an aircraft structure using fixing elements 10. The housing is fixed at any predetermined position of an aircraft structure.

In FIG. 1, an opening 8 with a counter 7 is depicted. By another opening 8,′ service staff may offer certain services from the interior of the structure through the opening at the counter 7. For example, entertainment programs for children, such as a puppet theater, may be performed or giveaways or other items such as supplies from the destination country may be offered.

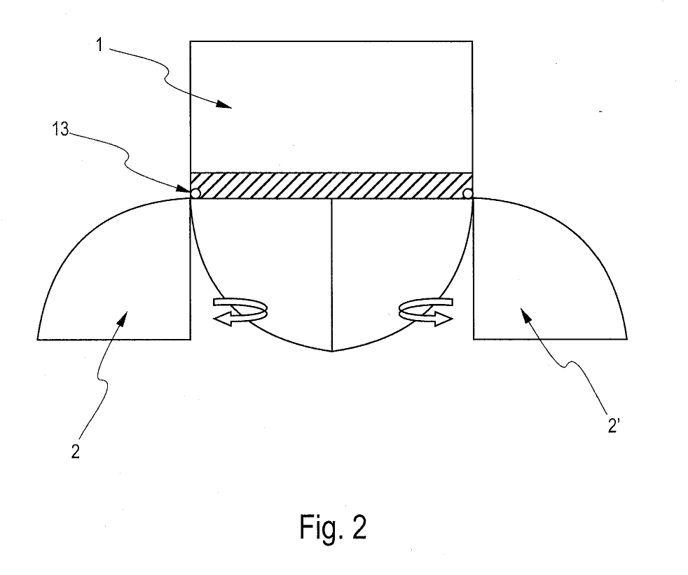

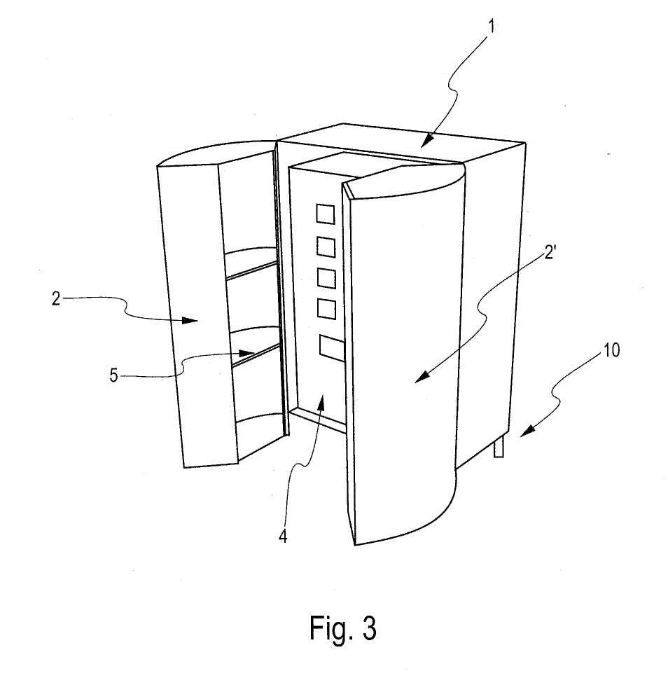

FIG. 2 shows a schematic representation whereby the structure additionally has a first and a second door element 2, 2′, mounted to the structure 1. The door elements 2, 2′ are hereby flexibly mounted. In the respective closed state, space may be saved, while in the opened state, further service devices 4, an example of which is shown in FIG. 3, may be installed in the door elements 2, 2′, such that the functional range may be extended over and above the structure.

FIG. 3 shows a three-dimensional representation of the structure with an structure 1 and the first and the second door elements 2, 2.′ Furthermore, the fixing elements 10 connect the housing of the structure to any position of the aircraft by fastening units on the aircraft. In this embodiment, the fixing elements 10 is fixed to the same seat slides in the aircraft floor to which the seats are fixed. Thus, a cost-efficient possibility of fixing is provided, since no further adjustments have to be carried out in the aircraft.

Furthermore, built-in areas 5 of the doors 2, 2′ allow further installation of service devices 4. In the embodiment of FIG. 3, another service device 4 is fixed to the structure 1. For example, the service device 4 may be a snack or a fast food dispenser whereby table napkins or cutlery are available in the first door element 2 and in the second door element 2′, further accessories or additional products, such as, ketchup or mayonnaise etc., are provided. Thus, an extensive and flexible structure is provided.

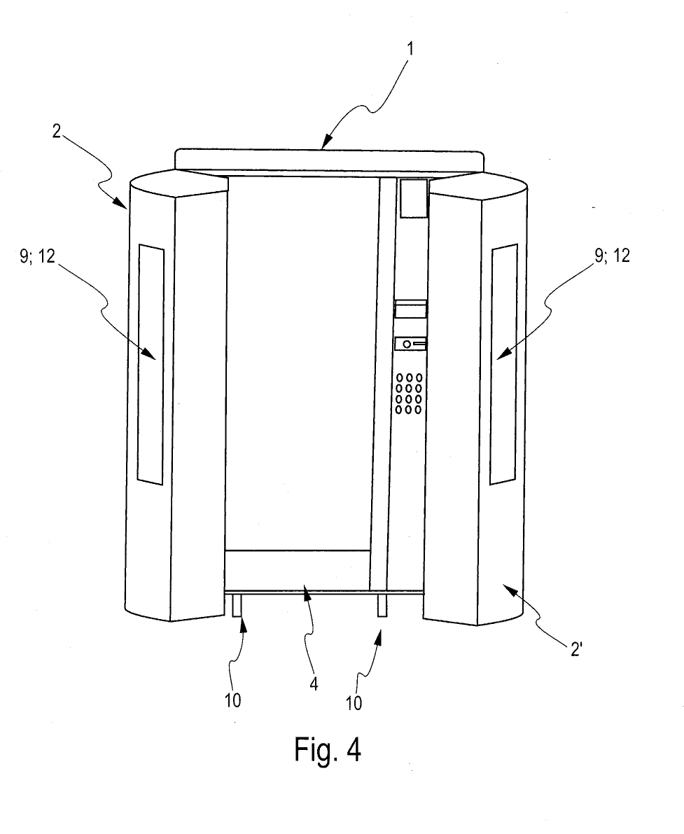

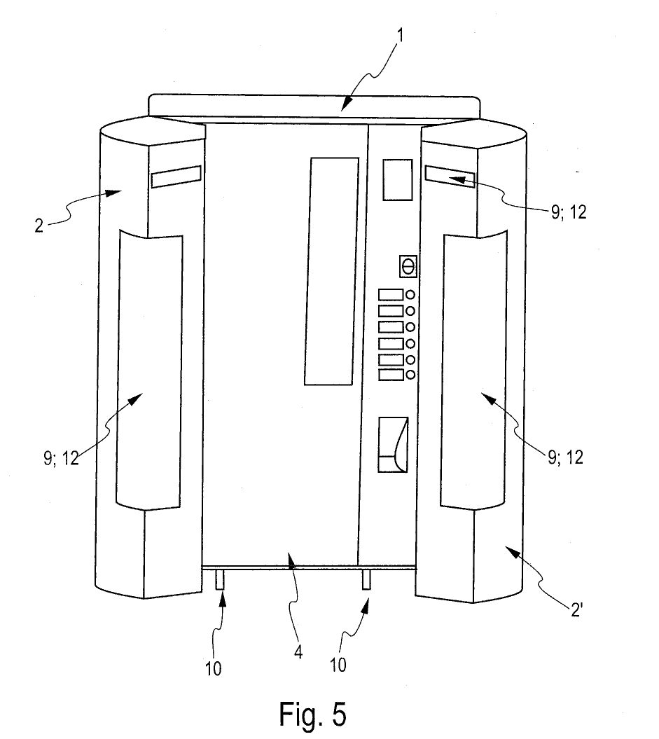

FIG. 4 shows another embodiment in which the structure 1 includes a service device 4 for snack food. The first and the second door elements 2, 2′ have a different geometric form than the door elements shown in FIG. 2, for example. Via the same fixing elements 10 as in FIG. 2, the geometrically differently shaped door elements 2 and 2′ of FIG. 4 or 5 may be mounted to the structure 1. Thus, it may be flexibly complied with the requirements and the field of application of the structure.

As shown in FIG. 5, advertising media 12 are exchanged. This differs from the placement of advertising media in FIG. 4. Thus, every airline may react flexibly to different contracting parties and generate new revenue streams. Despite having a different geometric form, in one example, the advertising media 12, as shown in FIG. 5, may be flexibly fixed to the removable module 9 of the door elements 2, 2′ by fasteners 13.

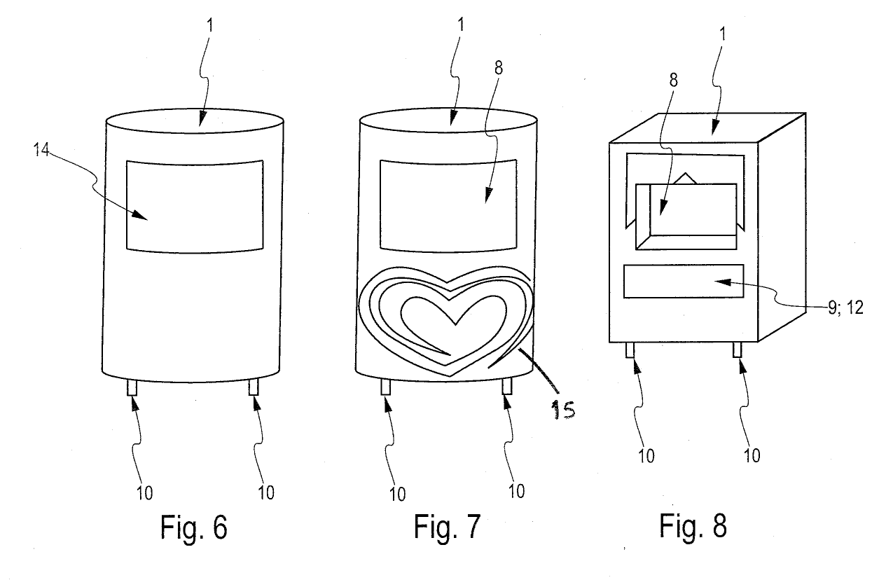

FIGS. 6 to 8 show these additional embodiments of structures 1, including a housing coupled to fixing elements 10. By means of a built-in area 14, a screen device may be fixed. The entertainment program during the flight is thus improved. Alternatively, an opening 8 may be used for other purposes. In FIG. 7, an ornamental design 15 is displayed on the structure 1. In FIG. 8, a removable module 9, with media 12 may be used for any purpose. For example, 9, 12 may be used for advertising and/or other purposes.

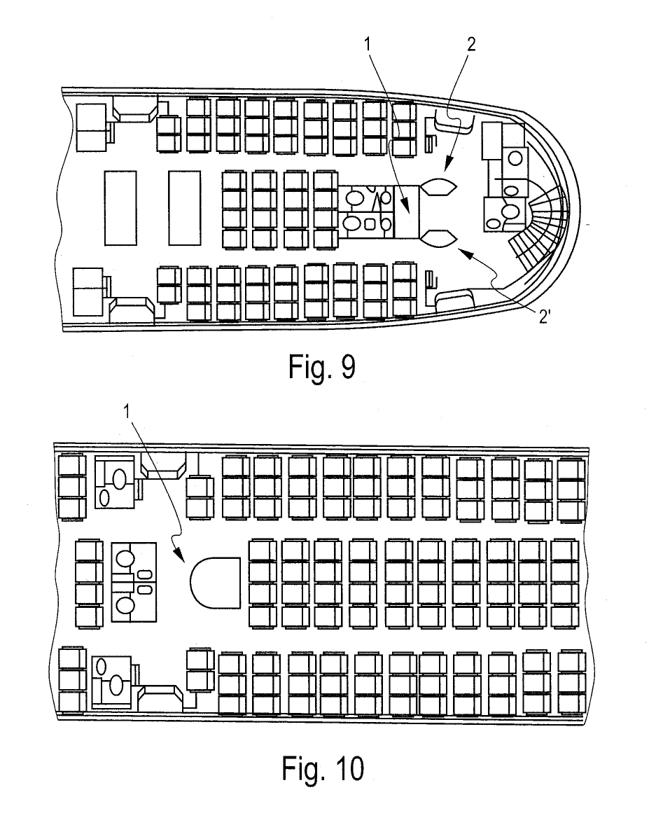

FIG. 9 shows an cabin layout where the structure is installed. FIG. 9 shows the structure in use, in which the first and the second door elements 2 and 2′ are open. The passenger may move towards the structure and to use the offered service. By the extension of the service offers, passenger satisfaction may be increased.

In FIG. 10, the structure is shown in the closed state. In one example, the closed state is an inactive state. As shown in FIG. 10, the door elements 2, 2′ are closed, and hence, the space requirement of the structure is reduced. Particularly in critical phases, as in the takeoff and the landing, more space for emergency exits may be made and furthermore, the risk of injury by the sharp edges of an opened structure may be reduced.

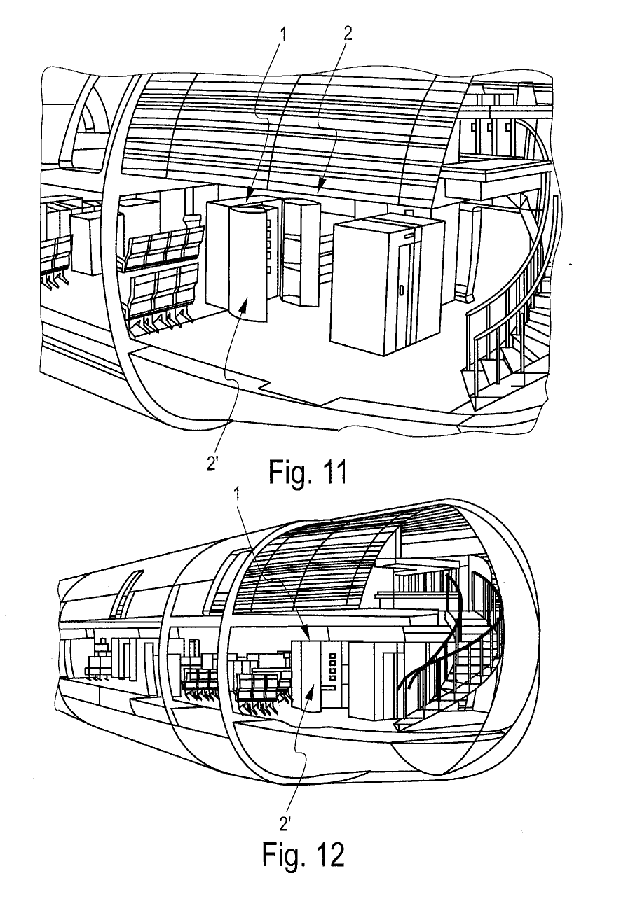

FIGS. 11 and 12 furthermore show a three-dimensional representation of a cabin layout in which one example of the structure is mounted. Particularly in modern aircraft, for example, the Airbus model A380, these additional service units, as the structure, may be mounted in the cabin due to the larger space and offer a broader service offer for the customer.

Let it additionally be noted that “extensive” does not preclude any other elements or steps, and “one” or “a” do not preclude a plurality. Further, let it be noted that features or steps that were described with reference to one of the above embodiments may also be used in combination with other features or steps in other embodiments described above. Reference numbers in the claims are not to be regarded as limiting.

What is claimed is:

1. A structure for use in an aircraft with fixing elements coupled to an aircraft structure comprising a housing; the structure having an opening and an interior with built-in-areas;
the housing being fixable at a predetermined position of the aircraft structure;
a removable module modularly mountable to the housing and having an advertising medium;
a first door element and a second door element;
housing fixing elements for fixing the housing to fixing elements of the aircraft structure; and
a built in-area, at least one from the group consisting of the first door element and the second door element has the built-in areas and a service unit is mounted to at least one of the built-in areas.

2. The structure of claim 1, wherein the fixing elements are dimensioned in such a way to be coupled with a seat slide of an aircraft floor.

3. The structure of claim 1, wherein the advertising medium is capable of being fixed to the at least one removable module.

4. The structure of claim 1, wherein the opening comprises a window and a counter.

5. The structure of claim 3, wherein at least one from the group consisting of the first door element, the second door element, the advertising medium, and the built-in area is modularly replaceably mountable to the structure.

6. The structure of claim 3, wherein at least one from the group consisting of the first door element, the second door element, the removable module of the built-in area and the advertising medium includes fasteners.

7. The structure of claim 6, wherein the fasteners are selected from the group consisting of hook and loop connections, plug connections, magnetic connections, staple connections, glue connections, put over connections (Stülpverbindungen), screw connections, and welded connections.

8. The structure of claim 1, wherein a service unit is selected from the group consisting of a magazine and newspaper dispenser, a drinks dispenser, an information automat, an Internet kiosk or desk, a ticket machine, a fast food dispenser, and a snack dispenser.

9. The structure of claim 1, wherein a screen device is mounted to at least one of the built-in areas.

10. The structure of claim 3, wherein at least one from the group consisting of the structure, the first door element, the second door element, the removable module, and the advertising medium comprises lighting elements for producing light effects and light reflections.

11. The structure of claim 3, wherein the advertising medium is selected from the group consisting of posters, foils, company-specific geometric forms, and characters.

12. A method for operating a structure having fixing elements capable of dimensioned in such a way to couple with a seat slide of an aircraft floor for an aircraft, comprising:
mounting a modular construction with at least one removable module to a housing; the housing being fixable at a predetermined position in the aircraft;
fixing advertising media to the removable module;
fixing the housing via fixing elements that fix the housing to fixing elements of an aircraft structure;
mounting a first door element and a second door element at the modular construction;
mounting at least one build-in area to at least one from the group of the first door element, the second door element and the modular construction;
and mounting a service device to at least the one built-in area.

13. The method according to claim 12, further including a step of fixing the housing of the structure to a seat slide in an aircraft.

14. The method according to claim 12, further comprising a step of mounting at least one from the group consisting of the first door element, the second door element, the removable module, and the advertising medium to the structure via fasteners.

15. The method according to claim 12, further comprising a step of disassembling the first door element and the second door element that are mounted to the structure; mounting a third door element and a fourth door element, the third and forth elements having geometric forms which differ from those of the disassembled first and second door element.

16. The method according to claim 12, further comprising a step of fixing advertising media to the removable module.

17. The method according to claim 12, further comprising a step of mounting a screen device to at least the one built-in area.

18. The method according to claim 12, further comprising a step of producing light effects or light reflections from at least one from the group consisting of the structure, the first door element, the second door element, the removable module, and the advertising medium.

19. An aircraft with a structure according to claim 1.

20. The use of the structure according to claim 1 in an aircraft.
